(19) United States
(12) Patent Application Publication
(10) Pub. No.: US 2005/0268762 A1
(43) Pub. Date: Dec. 8, 2005

(54) Web treatment machine with at least one vacuum chamber

(76) Inventors: Stefan Hein, Blankenbach (DE); Gunther Gerber, Mombris (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/143,064

(22) Filed: Jun. 2, 2005

(30) Foreign Application Priority Data
Jun. 2, 2004 (EP) 04 013 028.8

(51) Int. Cl. B26D 1/02

(52) U.S. Cl. 83/13; 83/856

(57) ABSTRACT

In a web treatment machine, in particular a web coater, having at least one evacuable working area through which the continuous web passes during treatment thereof, a unit for the continuous longitudinal cutting of the web is provided according to the invention directly in the evacuable working area. This permits longitudinal parting of the fully or partially treated web prior to winding up thereof, so that the individual strips of cut web can then be fed, without contact with the surroundings, to different reels.

### CROSS-REFERENCE TO RELATED APPLICATION

This application claims priority to European Patent Application No. 04013028.8, filed on Jun. 2, 2004, entitled WEB TREATMENT MACHINE WITH AT LEAST ONE VACUUM CHAMBER.

### FIELD OF THE INVENTION

The invention relates to a web treatment machine, in particular a coater for coating continuous web.

### BACKGROUND OF THE INVENTION

Many different kinds of web treatment machines are known (e.g., WO 99/50 472 and EP 1 306 888 A2, the entire contents of which are hereby incorporated herein by reference). They are used for the treatment, in particular, the coating, of flexible web substrates (e.g., plastic sheeting, magnetic tapes, films, etc.) under vacuum (e.g., by means of sputtering of targets, possibly with the help of magnetic fields, or PVD or CVD vapor deposition), but also for other forms of treatment, such as pre-treatments, cleaning, drying, surface activation, polymerisation, etc.

It may be necessary to cut the fully treated continuous web longitudinally, for example in order to trim the edges and produce a defined web width, or to wind up several strips of the same or different widths independently of each other or to feed them to further treatment stages.

Until now, the corresponding cutting stations or systems have been located outside the web treatment machines, downstream of the actual treatment or coating tract (here, downstream means the direction in which the web moves through the machine, whereas upstream means against the direction of web movement). Examples of such machines are known, for example, from EP 1 334 936 A1 or from the German laid-open print DE-OS 1 932 341, the entire contents of which are hereby incorporated herein by reference. The latter publication describes a reel trimmer and winder in which a paper web is guided via a first spreader roll into the area of the longitudinal cutting device, which comprises an upper and a lower knife, and then, after it has been cut, via a second spreader roll to a winder.

The term “spreader roll” refers to a roll on which a web guided over it is stretched transversely by contact with a special surface of the roll such that longitudinal wrinkles are prevented altogether or smoothed out. Rolls of this kind are likewise known per se (e.g., DE 38 90 004 C1, the entire contents of which are hereby incorporated herein by reference).

The object of the invention is to provide a web treatment machine with at least one additional function, which makes it possible to reduce the overall length of a treatment machine.

This object is established according to the invention with the features of claim 1. The features of the subclaims represent useful developments of the invention.

### SUMMARY OF THE PRESENT INVENTION

According to the invention, a longitudinal cutting unit, that is, an appropriately equipped module, is provided directly inside a vacuum treatment area of the web treatment machine, so that this unit is an integral component of the actual treatment machine. This allows the continuous web to be cut longitudinally directly after the treatment process, e.g., coating, and then guided further in at least two separate strips. In one embodiment of the illustrated invention, the strips can then be rolled up immediately, while still in the machine and maybe still under vacuum, so that the risk of contamination between leaving the evacuated area and the cutting process on the one hand, and the wind-up process on the other hand, is minimized. Particles that may form during the cutting process will be much easier to remove from the continuous web by way of gravity while under vacuum than in a ventilated environment that is more likely to keep such small particles in suspension, enabling them to settle undesirably on the web.vironment, tilated environment, Il be much easire in the machine and maybe still under vacuum, so that the

It is of course possible, for one thing, to provide several parallel knives or blades in order to cut the continuous web longitudinally into more than two strips and, for another, to mount the knife or knives movably, thus allowing them to be removed from the web's plane of transport; these measures make it possible to obtain either uncut webs or an arbitrary number of strips having the same or different widths.

According to one embodiment, the continuous web is guided, at least downstream of the longitudinal cutting unit, over a spreader roll. An advantage here is that the strips generated by cutting the web can be guided at least slightly apart, so that they can be wound up separately without their edges overlapping.

The actual cutting process can be performed according to at least two methods. With the first method, the continuous web is guided wrinkle-free to the cutting unit via a first spreader roll and maybe a deflecting roll. The deflecting roll stabilizes the substrate.

The longitudinal cutting unit includes at least one knife and is positioned directly after the deflecting roll. During cutting, the knife dips into the web's plane of transport immediately after the deflecting roll, thus cutting the freely running web on the downstream side of the roll.

The downstream spreader roll smoothes and separates the cut strips.

According to the second method, the dip-down point of the cutting unit's knife or knives is in the area of the deflecting roll located downstream of a first spreader roll. The deflecting roll is in this case provided with at least one circumferential slot or groove, into which the knife can dip after passing through the plane of the web substrate. With this arrangement, the web substrate is cut directly on the deflecting roll.

It would also be conceivable to cut the substrate, after it has been guided over a (first) spreader roll, directly after it runs onto a (second) spreader roll, thus making the overall machine possibly even more compact. With this arrangement, the substrate, immediately after it has been cut, could already be separated longitudinally, that is, the cut strips guided apart, on the same roll.

It is further conceivable to locate the cutting point at a position immediately in front of where the web runs onto a roll, so that, in this case, the knife or knives cut the web on the upstream side of the roll.

Whichever of these variants is used, it is essential that the continuous web to be cut longitudinally is well supported in the vicinity of the cutting knife, in other words, that the web is cut immediately downstream of a roll, immediately upstream of a roll, or that, on either side of the cutting area, it is still supported on a roll, in which case the knife dips into the roll's circumferential recess. Otherwise, there is a risk that at high web speeds, a discontinuous cut will be obtained, as the knife may push down the continuous web without cutting it.

Further details and advantages of the subject of the invention are apparent from the simplified drawings of two embodiments and the subsequent detailed description thereof that follows.

### BRIEF DESCRIPTION OF THE DRAWINGS

FIG. 1 is a block diagram of a web treatment machine with an integrated cutting unit.

FIG. 2 shows a first embodiment of the integrated cutting unit; in this embodiment, a knife dips into the periphery of a deflecting roll over which the continuous web is guided.

FIG. 2a shows, as a detail from FIG. 2, the deflecting roll with a circumferential groove so that the knife can dip into the periphery of the roll.

FIG. 3 shows a second embodiment of the integrated cutting unit, in which a knife cuts the web longitudinally immediately after it has passed over a deflecting roll.

### DETAILED DESCRIPTION OF THE PREFERRED EMBODIMENTS

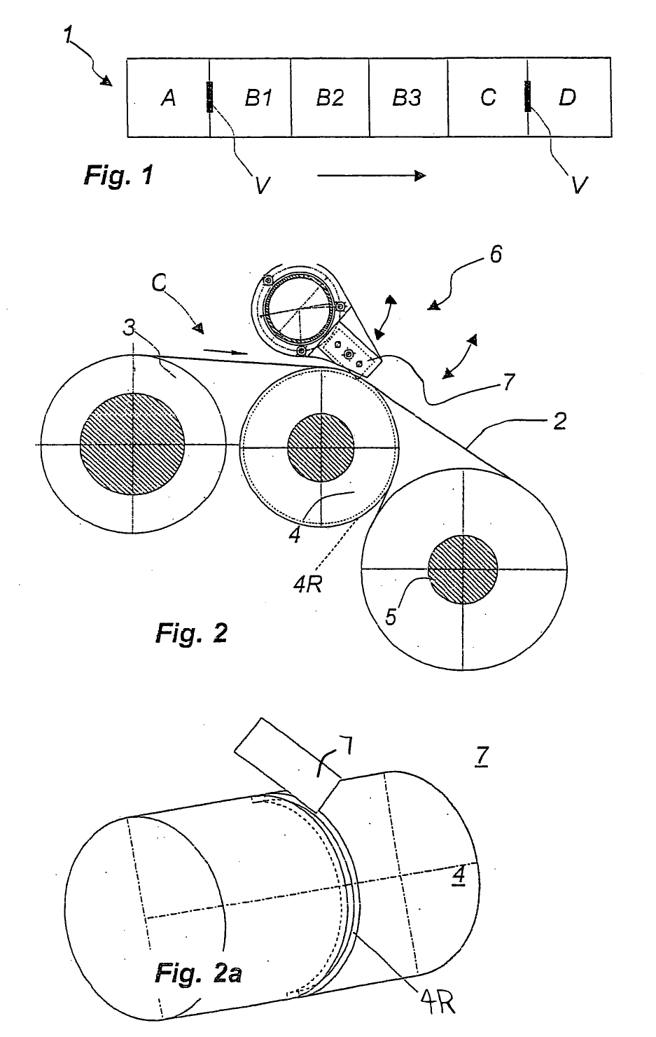

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

According to FIG. 1, a modular web treatment machine 1 comprises an unwind module A, into which untreated continuous web wound on a reel is inserted and then guided from left to right through the machine in the direction of the arrow. The module A is followed by at least one treatment module B1 (and maybe additional treatment modules B2, B3, Bx), a cutting unit C and a wind-up module D.

During operation, these modules A to D can all be evacuated if the web treatment so requires (e.g., for a magnetron coating process, cathode sputtering or CVD).

In this case, air-lock valves may be provided between individual modules, if necessary at every transition from one module to the next, which make it possible to ventilate or evacuate the modules independently of each other.

This applies particularly to the transitions to the unwind and wind-up modules, which have to be exposed periodically to the air anyway when the reels of continuous web are inserted or removed. In FIG. 1, an air-lock valve V representative of any possible and expedient arrangement of air-lock valves is shown between the unwind module A and a first coating module B1, and between the cutting unit C and the wind-up module D.

While in the treatment modules B1, B2, etc., the continuous web is provided, by way of example, with coatings not described further here, or else undergoes other forms of treatment, the cutting unit serves to cut the fully treated web online, i.e. still within the machine, preferably under vacuum and before it is wound up in module D, longitudinally into at least two parallel strips.

It would, of course, also be possible to temporarily not use the cutting unit, i.e. not to bring the knives or blades mounted therein into contact with the continuous web, so that if desired, also uncut, fully treated web can be conveyed to the wind-up module D.

At least one wind-up reel is preferably provided in the wind-up module D, there being the additional option of winding up the strips (generated by longitudinal cutting of the web) on different reels.

Obviously, it would also be possible to position the cutting unit C between two treatment modules Bx, By (thus deviating from the illustration), so that after the web has been parted longitudinally, the strips thus generated can be subjected to further treatment stages. In principle, it would also be possible to subsequently subject the individual strips to different treatments, so that on completion of processing, different end products could be removed from a machine supplied with a uniform starting material.

It is further conceivable to expel strips that have been cut off, e.g. edge trimmings, from the machine via air-lock valves and to use them for other purposes or maybe to recycle them.

Since web treatment machines may be considered as being known per se, the following description focuses on the cutting unit.

According to FIG. 2, the cutting unit C through which a continuous web 2 passes includes a first spreader roll 3, a deflecting roll 4 and a second spreader roll 5. The direction in which the web moves is again indicated by an arrow above the spreader roll 3. Above the deflecting or backing roll 4, a cutting device 6 can be seen, which is equipped with at least one blade or one knife 7. The double-headed arrow to the right of the cutting device 6 indicates that this is movable and can move the knife 7 out of contact with the web 2.

However, in the position illustrated here, the knife 7 dips into the plane of transport of the web 2. It is apparent from the detail shown in FIG. 2a that the deflecting roll 4 is provided in the relevant area with a circumferential groove 4R; although the groove is covered by the web 2, the knife 7 can dip into it, thereby penetrating the web 2 and parting it longitudinally.

This configuration ensures that the web 2 is supported well on both sides of the continuously cutting position, so that once the web 2 has been stretched transversely on the spreader roll 3, no web deformations or deviations are possible. This variant is preferred for continuous webs that are especially thin and flexible.

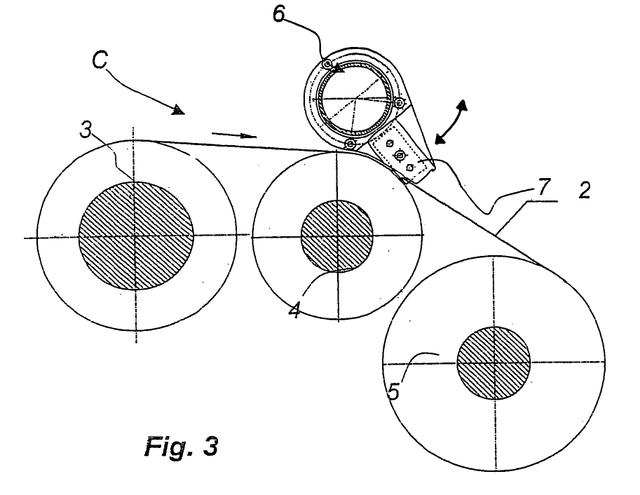

The version of the cutting-unit C shown in FIG. 3 has no groove in the deflecting roll 4. Here, the knife 7 of the cutting device 6 dips into the plane of transport of the web 2 downstream of the deflecting roll 4, in the immediate vicinity of the (smooth) surface thereof. The knife blade is in this case practically tangential to the surface of the roll. At this proximity to the roll, the web is not able to deviate from its defined path. This cutting-unit version, which is of a simpler configuration particularly with respect to the deflecting roll, may be used preferably for relatively stiff continuous webs. This cutting device, too, is preferably movable; its drive is not illustrated here.

It goes without saying that during operation, the cutting devices can be firmly locked in position such as to prevent any impairment to the cutting results on account of undesired movements of the knife relative to the deflecting roll 4.

The knives or blades of the cutting device will of course be designed such that they are exchangeable; it is evident from the Figures that the knives 7 are mounted releasably in holders of the cutting units.

It is to be understood that variations and modifications can be made on the aforementioned structure without departing from the concepts of the present invention, and further it is to be understood that such concepts are intended to be covered by the following claims unless these claims by their language expressly state otherwise.

1. A web treatment machine comprising:
at least one evacuable working area through which a continuous web passes during treatment thereof; and
a cutting unit for continuous longitudinal cutting of the web provided directly in the evacuable working area.

2. The web treatment machine of claim 1, further including:
a treatment module located upstream of the cutting unit.

3. The web treatment machine of claim 1, further including:
a treatment module located upstream of the cutting unit; and
a wind-up module located downstream of a wind-up module.

4. The web treatment machine of claim 1, further including:
at least two different treatment modules;
wherein the cutting unit is located between at least two of the at least two different treatment modules.

5. The web treatment machine of claim 4, wherein:
an air-lock valve is provided between each of the modules.

6. The web treatment machine of claim 1, further including:
at least one spreader roll located at least downstream of the cutting unit.

7. The web treatment machine of claim 6, wherein:
the spreader roll located downstream of the cutting unit is engineered such that it guides parallel strips of web after it has been cut on a surface of the spreader roll longitudinally apart, so that the strips can be wound up separately.

8. The web treatment machine of claim 1, further including:
at least one spreader roll located upstream of the cutting unit.

9. The web treatment machine of claim 1, wherein:
the cutting unit includes at least one movable cutting device with at least one knife that is movable in and out of contact with the continuous web.

10. The web treatment machine of claim 1, wherein:
the cutting unit includes at least one deflecting roll, with at least one knife being disposed in the immediate vicinity of a surface of the deflecting roll.

11. The web treatment machine of claim 10, wherein:
the at least one knife is designed to part the web directly on a downstream side of the deflecting roll.

12. The web treatment machine of claim 10, wherein:
the at least one knife is configured to part the web directly on an upstream side of the deflecting roll.

13. The web treatment machine of claim 10, wherein:
the deflecting roll is provided with at least one circumferential groove into which the at least one knife of the cutting unit dips during a cutting operation.

14. The web treatment machine of claim 1, further including:
a wind-up module that can be fitted with one or more reels for winding up the web after the web is cut.

15. A method of cutting a continuous web comprising:
providing at least one evacuable working area;
passing the continuous web through the at least one evacuable working area during treatment thereof;
providing a cutting unit for continuous longitudinal cutting of the web directly in the evacuable working area; and
cutting the web with the cutting unit.

16. The method of cutting a continuous web of claim 15, further including:
locating a treatment module upstream of the cutting unit.

17. The method of cutting a continuous web of claim 15, further including:
locating a treatment module upstream of the cutting unit; and
locating a wind-up module downstream of a wind-up module.

18. The method of cutting a continuous web of claim 15, further including:
providing at least two different treatment modules; and
locating the cutting unit between at least two of the at least two different treatment modules.

19. The method of cutting a continuous web of claim 18, further including:
providing an air-lock valve between each of the modules.

20. The method of cutting a continuous web of claim 15, further including:
locating at least one spreader roll at least downstream of the cutting unit.

21. The method of cutting a continuous web of claim 20, further including:
guiding parallel strips of the web after the web has been cut longitudinally apart with the spreader roll; and
winding the strips up separately.

22. The method of cutting a continuous web of claim 15, further including:
locating at least one spreader roll upstream of the cutting unit.

23. The method of cutting a continuous web of claim 15, further including:
providing the cutting unit with at least one knife; and
moving the at least one knife in and out of contact with the continuous web.

24. The method of cutting a continuous web of claim 15, further including:
providing the cutting unit with at least one deflecting roll; and
disposing at least one knife in the immediate vicinity of a surface of the deflecting roll.

25. The method of cutting a continuous web of claim 24, further including:
parting the web with the at least one knife directly on a downstream side of the deflecting roll.

26. The method of cutting a continuous web of claim 24, further including:
parting the web with the at least one knife directly on an upstream side of the deflecting roll.

27. The method of cutting a continuous web of claim 24, further including:
providing the deflecting roll with at least one circumferential groove; and
dipping the at least one knife into the at least one circumferential groove during cutting.

28. The method of cutting a continuous web of claim 15, further including:
providing a wind-up module with one or more reels for winding up the web after the web is cut.
